(19) United States
(12) Patent Application Publication
(10) Pub. No.: US 2013/0238449 A1
(43) Pub. Date: Sep. 12, 2013

(54) Polymorphic Advertisements

(71) Applicants: Ian Ferreira, Issaquah, WA (US); Pavel Berkhin, Sunnyvale, CA (US)

(72) Inventors: Ian Ferreira, Issaquah, WA (US); Pavel Berkhin, Sunnyvale, CA (US)

(73) Assignee: MICROSOFT CORPORATION, Redmond, WA (US)

(21) Appl. No.: 13/416,303

(22) Filed: Mar. 9, 2012

(51) Int. Cl. G06Q 30/02

(52) U.S. Cl. 705/14.72

(57) ABSTRACT

Various embodiments pertain to techniques for generating advertisement templates for use in various technological environments. In various embodiments, an advertiser can select one or more advertisement templates and provide the specified components to an advertisement service. The advertisement service can bind the components into a selected template for presentation to a user, depending on a number of factors. For example, in some embodiments, the device capabilities can determine the template that is used, while in other embodiments, information regarding a user's previous interaction with the content can be used to determine the template that is used. For example, a user that is seeing an advertisement for a particular product for the first time may be presented one version of the advertisement, while a user that is already a consumer of the product or has already viewed an initial advertisement may be presented with a different version of the advertisement.

### BACKGROUND

An advertiser typically seeks to reach as many viewers as possible with cost-effective advertisements. The cost to develop an advertising campaign increases as viewers use a greater variety of screens to access content associated with the advertisements because an advertiser typically prepares a different advertisement for each device or media channel. For example, an advertiser may have one version of an advertisement including video content when the advertisement is displayed to a viewer on a desktop computer, another version of the advertisement formatted for display on a mobile device, and a third version of the advertisement tailored for display via a gaming device. In addition to forcing advertisers to create various versions of advertisements with the same core message, this system requires advertisers to consider technical details such as limitations and abilities of various devices rather than remaining focused on creatively marketing the product or service.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments pertain to techniques for generating advertisement templates for use in various technological environments and enabling an advertiser's campaign to run seamlessly across a variety of devices. In various embodiments, an advertiser can select one or more advertisement templates and provide the specified components to an advertisement service. The advertisement service can bind the components into a selected template for presentation to a user, depending on a number of factors. For example, in some embodiments, the device capabilities can determine the template that is used, while in other embodiments, information regarding a user's previous interaction with the content can be used to determine the template that is used. For example, a user that is seeing an advertisement for a particular product for the first time may be presented one version of the advertisement, while a user that is already a consumer of the product or has already viewed an initial advertisement may be presented with a different version of the advertisement.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 illustrates an example operating environment in accordance with one or more embodiments;

FIG. 2 depicts an example display of a web page including an advertisement in accordance with one or more embodiments;

FIG. 3 illustrates a block diagram of an example template that can be used to generate an advertisement in accordance with one or more embodiments;

FIG. 4 is an example process of generating an advertisement using a template in accordance with one or more embodiments;

FIG. 5 shows an example decision tree that can be used to determine a template to be used to generate an advertisement in accordance with one or more embodiments; and

FIG. 6 is a block diagram of an example device that can be used to implement one or more embodiments.

### DETAILED DESCRIPTION

Overview

Various embodiments pertain to techniques for generating advertisement templates for use in various technological environments and enabling an advertiser's campaign to run seamlessly across a variety of devices. In various embodiments, an advertiser can select one or more advertisement templates and provide the specified components to an advertisement service. The advertisement service can bind the components into a selected template for presentation to a user, depending on a number of factors. For example, in some embodiments, the device capabilities can determine the template that is used, while in other embodiments, information regarding a user's previous interaction with the content can be used to determine the template that is used. For example, a user that is seeing an advertisement for a particular product for the first time may be presented one version of the advertisement, while a user that is already a consumer of the product or has already viewed an initial advertisement may be presented with a different version of the advertisement.

In various embodiments, one or more templates can include integration of one or more objects from third parties. Third parties can be partners with the advertiser, a social network, or other third parties whose objects can be used to enhance an advertisement. For example, an advertiser operating a restaurant may select an ad template that provides for integration with a social network or with a reservation booking service such that when the advertisement is viewed in a search engine results page (SERP), the advertisement can include a map indicating the location of the restaurant, a reservation request box, and/or comments about the restaurant from a user's social network connections.

In the discussion that follows, a section entitled “Example Operating Environment” describes an operating environment in accordance with one or more embodiments. Next, a section entitled “Example Embodiments” describes various embodiments for generating advertisement templates for use in various technological environments and enabling an advertiser's campaign to run seamlessly across a variety of devices. Finally, a section entitled “Example Device” describes a device that can be used to implement one or more embodiments.

Consider, now, an example operating environment in accordance with one or more embodiments.

Example Operating Environment

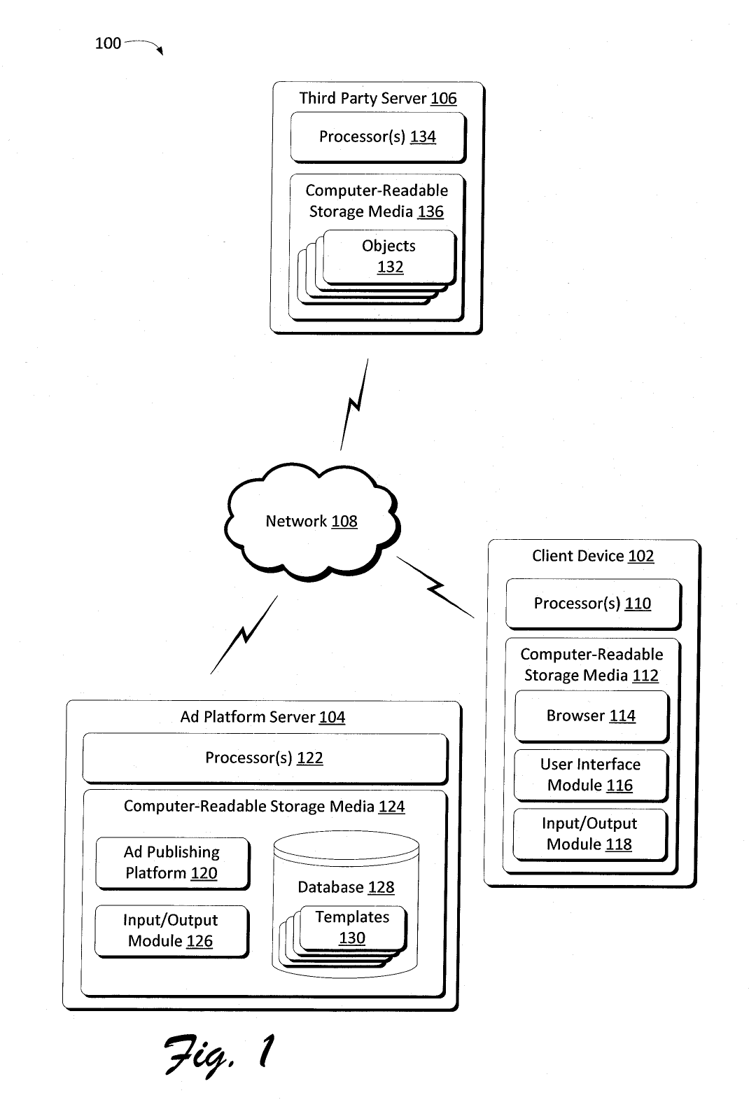

FIG. 1 is an illustration of an example environment 100 in accordance with one or more embodiments. Environment 100 includes a client device 102, an ad platform server 104, and a third party server 106 in communication through network 108. In various embodiments, a user can be presented an advertisement on client device 102 which is transmitted from ad platform server 104 via network 108 as described below in more detail. In some embodiments, the advertisement includes at least one object from third party server 106. The client device can be implemented as any suitable type of device, such as a mobile device (e.g., a mobile phone, portable music player, personal digital assistant, dedicated messaging device, portable game device, netbook, tablet, and the like), a personal computer, or another type of computing device.

In the illustrated and described embodiment, client device 102 includes one or more processors 110 and computer-readable storage media 112. Computer-readable storage media 112 can include various software executable modules, including browser 114. The computer-readable storage media also includes a user interface module 116 which is configured to manage user interfaces associated with executable modules that execute on the device and an input/output module 118.

The input/output module 118 communicates via network 108, e.g., to request a web page from a server and to receive displayable information from the server. The input/output module 118 may also include a variety of other functionality, such as functionality to make and receive telephone calls, form short message service (SMS) text messages, multimedia messaging service (MMS) messages, emails, status updates to be communicated to a social network service, and so on, depending on the particular embodiment. In the illustrated and described embodiment, user interface module 116 can, under the influence of ad publishing platform 120, cause an advertisement to be presented to a user.

Ad platform server 104 includes one or more processors 122 and computer-readable storage media 124. Computer-readable storage media 124 includes ad publishing platform 120, input/output module 126, and database 128. Ad publishing platform 120 is configured to manage and present advertisements, to a user via a user device, such as client device 102. In various embodiments, the ad publishing platform 120 is configured to generate an advertisement to be served to the client device by inputting advertisement components provided by the advertiser into one of the selected templates 130. Input/output module 126 is configured to communicate via network 108, e.g., to receive page requests and to transmit advertisements to other devices connected to the network. In various embodiments, database 128 is configured to store the templates 130. In some embodiments, database 128 can also store advertisement components provided by the advertiser, although in other embodiments, the ad publishing platform 120 is configured to retrieve the components from the advertiser's server.

In practice, ad platform server 104 can be representative of an advertisement management service that serves to cause various advertisements, in the form of sponsored links, pop-ups, ad banners, and web pages, to be displayed to users interacting with one or more executable modules on a user device, such as client device 102. Ads can be displayed to users via browser 114, or as part of a variety of other executable modules included on a user's device, such as a game or widget to provide information and content. More particularly, ad platform server 104, through input/output module 126, can receive a request from a client device, such as client device 102, via network 108 and search database 128 for a template to be used to generate an advertisement for presentation to the user. In particular, the ad publishing platform 120 determines a template from which the advertisement is built for the user.

Assume an advertiser, working with ad platform server 104, has selected various templates 130 for use in generating advertisements to be served to users. In addition to selecting one or more templates 130, the advertiser has provided various components, such as text information, images, videos, audio, or other types of content, to be used with the template to create an advertisement. Some of the templates selected by the advertiser can include all of the components provided by the advertiser while some of the templates selected by the advertiser can include only a portion of the components (e.g., one or more). For example, one template selected by the advertiser can include a hyperlink to the advertiser's web page and a snippet of text, and may be a template for an advertisement to be served as part of a search engine web page. Another template selected by the advertiser can include a short video along with text and a hyperlink to the advertiser's web page, and may be a template for an advertisement to be served while a web page requested by the client device, such as a desktop computer or laptop, loads. Yet another template selected by the advertiser can include other combinations of these and other components, and can be templates for advertisements to be served in other circumstances or when a request is received from a particular type of device (e.g., different templates can be used to generate advertisements served to a mobile device than to a personal computing device).

In various embodiments, a template selected by the advertiser enables integration of one or more objects 132 into the advertisement for presentation to a user. Objects 132 can be content items, widgets, or other objects provided by a party other than the advertiser to enhance the advertisement. For example, assume that the advertiser is a restaurant owner. Some templates selected by the restaurant owner can include a map showing the location of the restaurant, a reservation service widget that enables the user to make a reservation at the restaurant, publicly-posted reviews of the restaurant, or the like. Another template selected by the restaurant owner, such as a template for a version of the advertisement to be displayed on a mobile device, can include a widget to enable the user to call the restaurant. In embodiments in which objects 132 are integrated into the advertisement, the ad platform server 104 accesses the objects 132 from a server hosting the objects, such as third party server 106.

Third party server 106 includes one or more processors 134 and computer-readable storage media 136, on which various objects 132 reside. In various embodiments, ad platform server 104 transmits an advertisement to a client device that integrates one or more objects 132 into the advertisement. The content included on objects 132 can be controlled, generated, and modified by the third party, such as to additional services or information on products or services associated with the advertisement.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable memory devices. The features of the user interface techniques described below are platform-independent, meaning that the techniques may be implemented on a variety of commercial computing platforms having a variety of processors.

Having described an example environment, consider now a discussion describing creating an advertisement corresponding to a template utilizing components provided by the advertiser.

### Example Embodiments

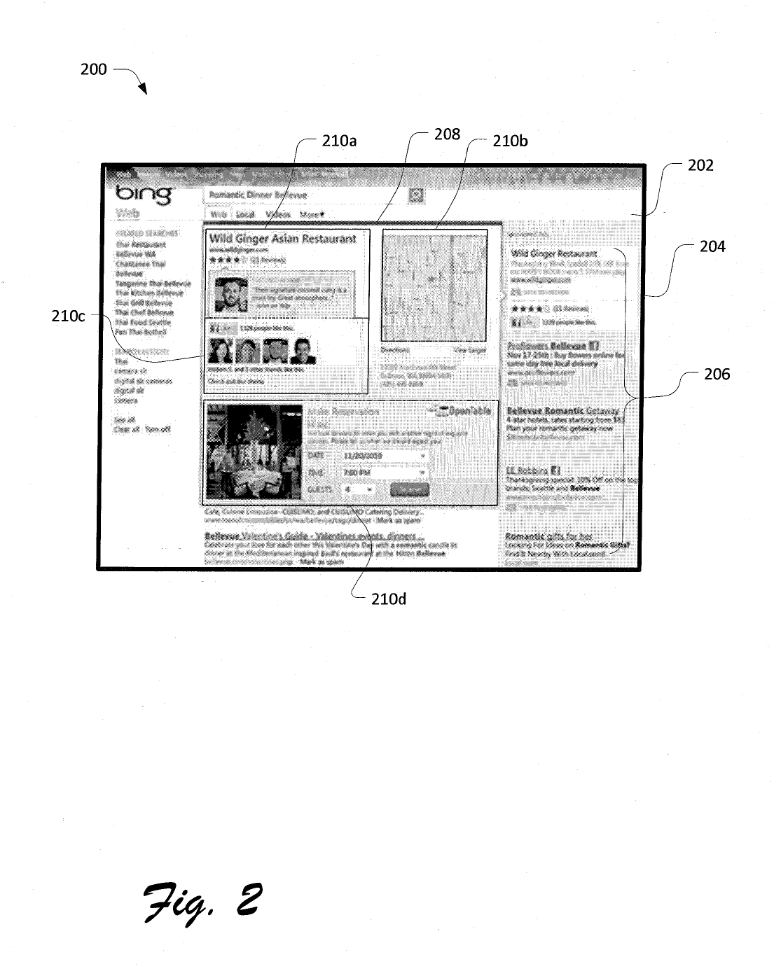

FIG. 2 illustrates an example view 200 of a web browser user interface displayed on a device. The view 200 illustrates but one example in which an advertisement can be created using a template.

FIG. 2 illustrates a web browser user interface 202 that is maximized within the viewing area 204 of a display. Web browser user interface 202 displays a search engine results page that includes a number of organic search results and a number of advertisements 206 provided to the side of the organic search results. Each of the advertisements 206 is presented in one of a number of advertisement slots. In view 200, one of the advertisements 206 has been selected for display as advertisement 208. Any one of advertisements 206 can be selected for display as an enlarged advertisement, such as when a user hovers a mouse indicator over the one of advertisements 206 or when a user otherwise selects one of advertisements 206, such as through the use of a mouse or touching the advertisement on a touch-screen display.

Advertisement 208, an advertisement for a restaurant, includes various objects, such as object 210a, 210b, 210c, and 210d. As shown in FIG. 2, object 210a includes various consumer reviews, such as reviews provided through Yelp® (Yelp® is a registered trademark of Yelp! Inc.) and object 210b is a map from Bing® illustrating the location of the restaurant (Bing® is a registered trademark of Microsoft Corporation). Object 210c is a graphical listing of others who have “liked” the restaurant on Facebook® (Facebook® is a registered trademark of Facebook, Inc.). Object 210d is a reservation widget from OpenTable® to enable a user to make a reservation at the restaurant directly from the advertisement 208 (OpenTable® is a registered trademark of OpenTable, Inc.). Each of these objects 210a, 210b, 210c, and 210d are provided and powered by a third party. In some embodiments, the advertiser has partnered with the third party, while in other embodiments, it is the ad platform that has partnered with the third party to provide advertisers additional functionality and options in their advertisements. In various embodiments, the advertiser has selected a template for advertisement 208 and provides components such as basic information about the advertised product or service, such as a name, location, website, and the like, that can be incorporated not only into advertisement 208, but also in the smaller advertisement included as one of advertisements 206.

In various embodiments, when an advertiser selects a template that integrates third party objects, the advertiser provides additional metadata or information to enable the object to be properly correlated with the advertisement. For example, the advertiser selecting the template for advertisement 208 can provide an image, OpenTable® identification information (e.g., an OpenTable ID), a location, a phone number, or the like. This additional information or metadata enables the ad platform to integrate the appropriate object into the ad. For example, it enables the ad platform to integrate a reservation request form for the advertised restaurant location rather than a reservation search box for any restaurant.

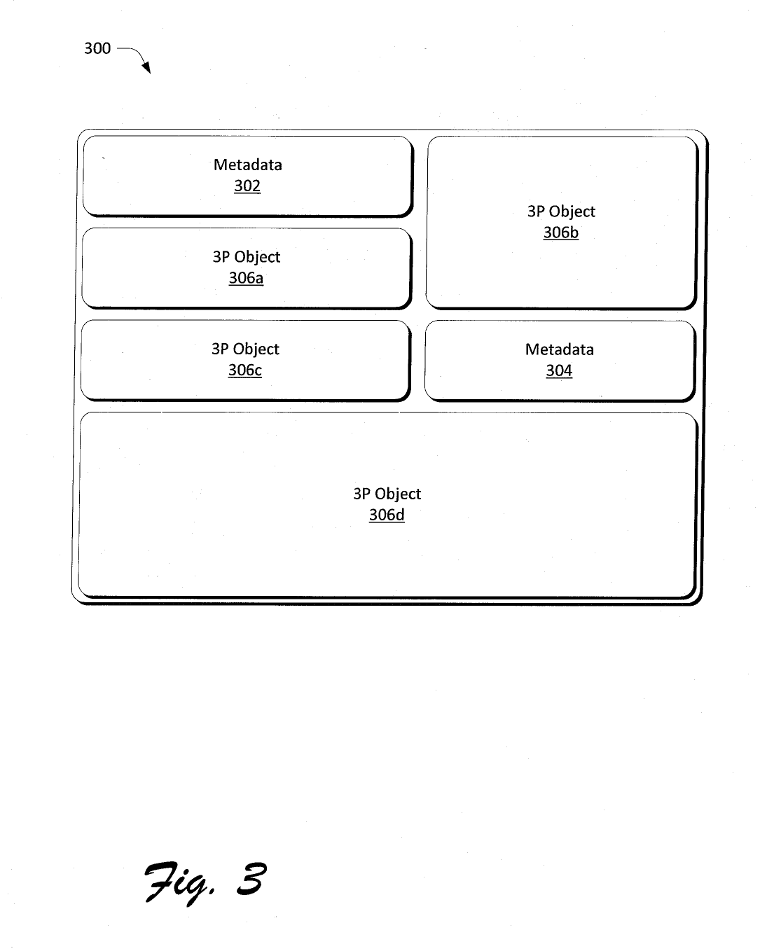

FIG. 3 is a block diagram of an example template 300 that can be used to generate an advertisement in accordance with one or more embodiments. Template 300 can be the template selected by an advertiser to generate advertisement 208, for example.

Template 300 includes various blocks in which various objects or components can be included when the advertisement is generated and served. In this particular example, template 300 includes metadata block 302 and metadata block 304, and third party objects 306a, 306b, 306c, and 306d. Components provided by the advertiser can be inserted into metadata blocks 302 and 304. For example, the restaurant name and website can be inserted into metadata block 302 and the restaurant address and telephone number can be inserted into metadata block 304. Other metadata or information can be inserted into the metadata blocks, depending on the particular embodiment.

Third party objects 306a, 306b, 306c, and 306d can be used to integrate various third party information or executable modules, as described above and below. For example, third party object 306a can provide integration with Yelp® to provide reviews, third party object 306b can provide integration with Bing® Maps to provide a map of the restaurant location, third party object 306c can provide integration with Facebook® to provide information regarding friends or connections who have “liked” or commented on the restaurant, and third party object 306d can provide integration with OpenTable® to provide reservation services.

The metadata or information to be provided by an advertiser can depend on the particular third party objects to be integrated according to the template. For example, when third party object 306a is a Yelp® object, it can be integrated when the advertiser provides the restaurant name and location. As another example, integration of a Bing® map can be provided when the location of the restaurant is provided. Other third party objects can require object identification codes, uniform resource indicators, or a means to identify the advertiser in a third party's database.

As described above and below, the templates selected by an advertiser can vary in size, shape, and the inclusion of third party objects. For example, an advertiser may select template 300 to serve as a basis for a search engine results page (SERP) view of an advertisement, select a different template to serve as a basis for a browser page view of the advertisement, and select a third template to serve as a basis for a mobile view of the advertisement.

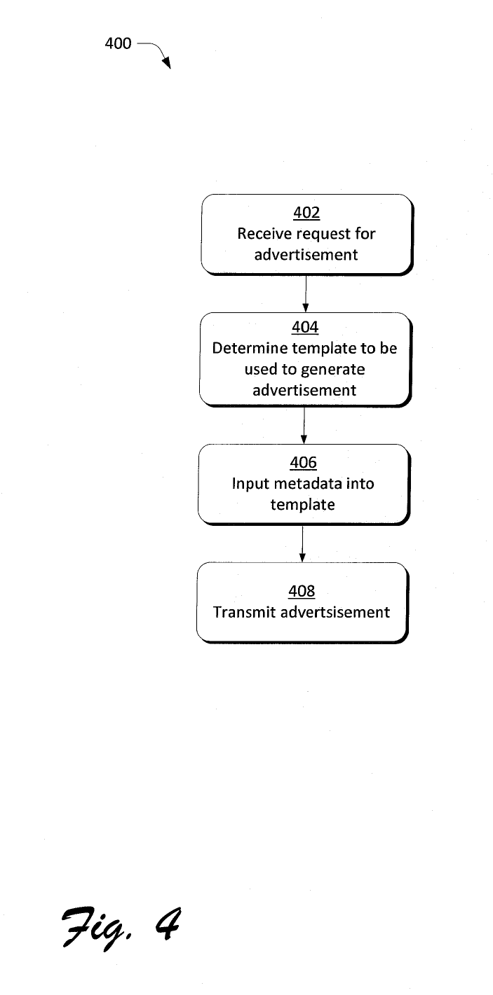

FIG. 4 depicts a flow diagram of an example process 400 for generating advertisements from templates. The process can be implemented in connection with any suitable hardware, software, firmware, or combination thereof. In at least some embodiments, the process can be implemented in software, such as ad publishing platform 120.

Block 402 receives a request for an advertisement. This can be performed in any suitable way. For example, an ad platform server, such as ad platform server 104, can receive a request for an advertisement from a client device, such as client device 102. In various embodiments, the request for an advertisement can include information regarding the user or the device requesting the advertisement. The information can include, for example, a user's log-in credentials (e.g., username and password) for one or more websites or web services, the size of a display on which the advertisement will be displayed, device capabilities, or whether the device is a mobile device or another type of device, such as a desktop computer. In some embodiments, the information can include information regarding the user's last visit to the website or a user's interaction with the advertiser.

Next, block 404 determines a template to be used to generate the advertisement based on at least one property of the request. This can be performed in any suitable way. For example, assume an advertiser selected several templates to be used for creating advertisements in the advertiser's campaign. Ad publishing platform 120 can select a template from the several templates chosen by the advertiser to be used in generating the advertisement in response to the request. In various embodiments, ad publishing platform 120 selects a template based on a variety of factors, which can include, by way of example and not limitation, properties of the request such as information regarding the device from which the request was received, information regarding a user, or a web page on which the advertisement will be presented. For example, ad publishing platform 120 may select one template when the device is a mobile device and another template when the device is a desktop computer. Likewise, ad publishing platform 120 may select one template when the advertisement will be served on a particular web page and a different template when the advertisement will be served on a SERP. As yet another example, ad publishing platform 120 may select one template when the advertisement will be served to a user that is not familiar with the advertiser or advertised product or service and a second template when the user has purchased the advertised product or service.

Block 406 inputs metadata into the template selected by block 404. This can be performed in any suitable way. For example, ad publishing platform 120 can input metadata provided by the advertiser into the template. The metadata can include information provided by the advertiser or a hook to enable integration with third party object providers.

In some embodiments, blocks 404 and 406 can be interchanged such that metadata is input into a template to generate the advertisement before a request is received. In such embodiments, responsive receiving the request, a version of an advertisement is selected based on at least one property of the request.

Block 408 transmits the advertisement. This can be performed in any suitable way. For example, ad platform server 104 can transmit code to enable browser 114 to render the advertisement within a browser user interface. In various embodiments, the code includes various scripts or other portions of code that can enable browser 114 to render the third party objects by requesting the object from the third party server.

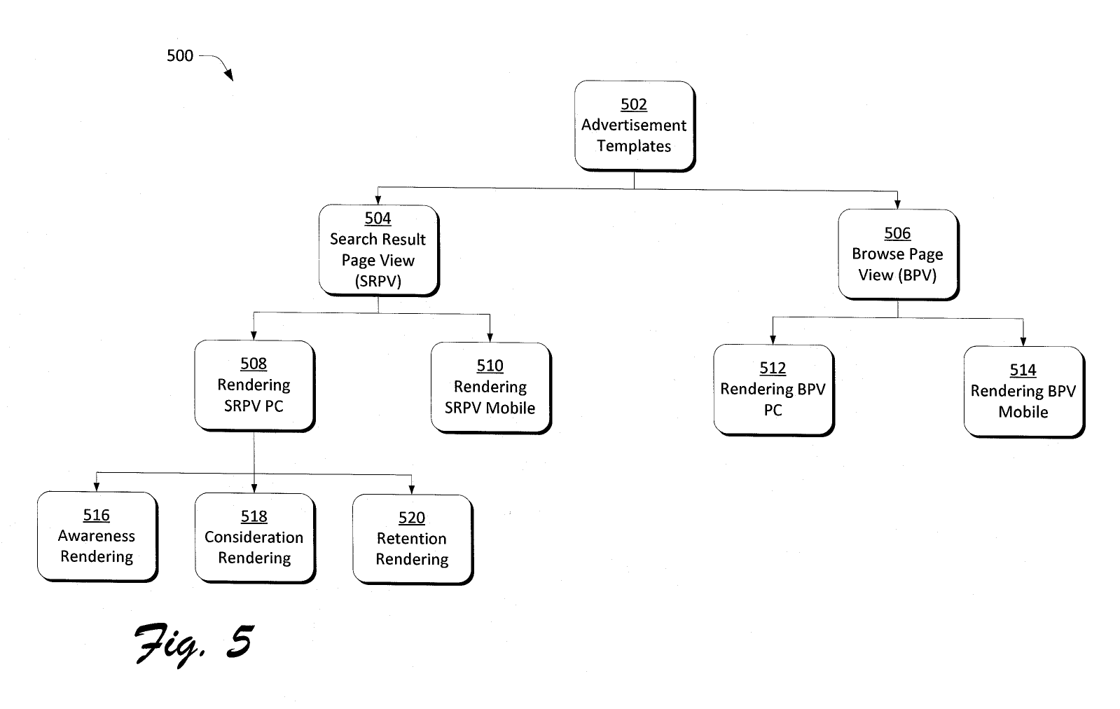

FIG. 5 illustrates an example decision tree 500 for use in determining a template to be used to generate an advertisement. In particular, the decision tree 500 in FIG. 5 is a decision tree that can be used in various embodiments in which templates enable an advertiser to target advertisements based on a user's progression through a sales funnel.

Block 502 represents the advertisement templates selected by a particular advertiser. An advertiser can select any number of advertisement templates, depending on the particular embodiment. In some embodiments, the number of advertisement templates selected by an advertiser can depend on the advertiser's budget or other factors.

The advertisement templates selected by the particular advertiser can be broken down into various groups. For example, in decision tree 500, the advertisement templates 502 are broken down into a group of templates to be used to generate advertisements in a search result page view (SRPV) 504 or a browse page view (BPV) 506. Templates to be used to generate advertisements in a SRPV 504 can further be broken down according to templates for use when the advertisement will be rendered by a personal computer 508 and templates for use when the advertisement will be rendered by a mobile device 510. Similarly, templates to be used to generate advertisements in a BPV 506 can further be broken down according to templates for use when the advertisement will be rendered by a personal computer 512 and templates for use when the advertisement will be rendered by a mobile device 514. In some embodiments, one or more templates can belong to more than one group. For example, the advertiser may select a single template to be used both in the SRPV rendered by a mobile device 510 and in the BPV rendered by a mobile device 514.

In the embodiment shown in FIG. 5, the templates to be used for generating advertisements as part of a SRPV rendered by a personal computer are still further broken down into templates for use when an advertisement is targeting a user at an “awareness” level 516 in the sales funnel (e.g., advertisements to make a user aware of the advertiser, product, or service), templates for use when an advertisement is targeting a user at a “consideration” level 518 in the sales funnel (e.g., when a user may be contemplating engaging with the advertiser or has already been made aware of the advertiser, product, or service), and templates for use when an advertisement is targeting a user at a “retention” level 520 in the sales funnel (e.g., when the user has already interacted with the advertiser, or purchased the advertised product or service). In various embodiments, information contained in the request for the advertisement received by the ad publishing platform enables the ad publishing platform to identify one or more templates for use in generating the advertisement in response to the request.

In various embodiments, information or data can be downloaded from a client device to enable the ad publishing platform to select a template or to enable a third party object to be integrated. For example, in some embodiments, information regarding a user's account with a third party providing an object integrated into the advertisement can be utilized to enable interaction with the object as though the user is signed in to the third party's services. For example, assume an advertisement for a movie includes an integrated ticket purchasing object, such as a widget from Fandango® (Fandango® is a registered trademark of Fandango, LLC). Data downloaded from the client device can indicate that the user has a Fandango® account, and when a user purchases tickets for the movie via the widget in the advertisement, the purchase can be processed using the user's account. In some embodiments, such data or information can be obtained through detecting one or more cookies on the client device.

Example Device

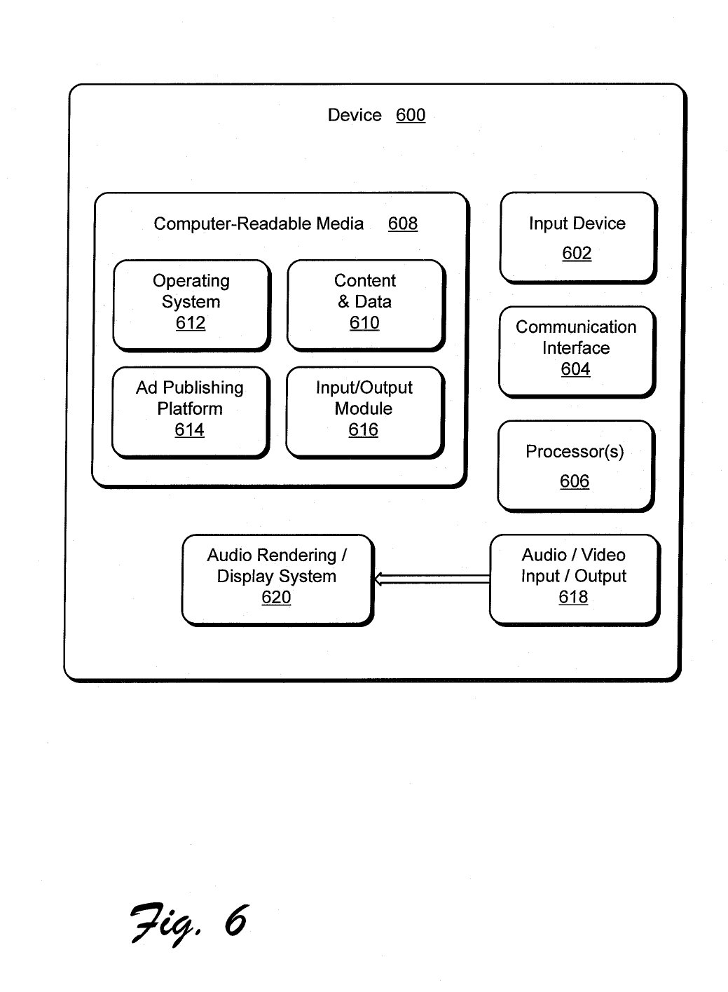

FIG. 6 illustrates an example computing device 600 that can be used to implement the various embodiments described above. Computing device 600 can be, for example, ad platform server 104 of FIG. 1, or any other suitable computing device.

Device 600 includes input device 602 that may include Internet Protocol (IP) input devices as well as other input devices, such as a keyboard. Device 600 further includes communication interface 604 that can be implemented as any one or more of a wireless interface, any type of network interface, and as any other type of communication interface. A network interface provides a connection between device 600 and a communication network by which other electronic and computing devices can communicate data with device 600. A wireless interface can enable device 600 to operate as a mobile device for wireless communications.

Device 600 also includes one or more processors 606 (e.g., any of microprocessors, controllers, and the like) which process various computer-executable instructions to control the operation of device 600 and to communicate with other electronic devices. Device 600 can be implemented with computer-readable media 608, such as one or more memory components, examples of which include random access memory (RAM) and non-volatile memory (e.g., any one or more of a read-only memory (ROM), flash memory, EPROM, EEPROM, etc.). A disk storage device may be implemented as any type of magnetic or optical storage device, such as a hard disk drive, a recordable and/or rewriteable compact disc (CD), any type of a digital versatile disc (DVD), and the like.

Computer-readable media 608 provides data storage to store content and data 610, as well as device executable modules and any other types of information and/or data related to operational aspects of device 600. The data storage to store content and data 610 can be, for example, database 128 to store templates 130. One such configuration of a computer-readable medium is signal bearing medium and thus is configured to transmit the instructions (e.g., as a carrier wave) to the hardware of the computing device, such as via the network 108. The computer-readable medium may also be configured as a computer-readable storage medium and thus is not a signal bearing medium. Examples of a computer-readable storage medium include a random access memory (RAM), read-only memory (ROM), an optical disc, flash memory, hard disk memory, and other memory devices that may use magnetic, optical, and other techniques to store instructions and other data. The storage type computer-readable media are explicitly defined herein to exclude propagated data signals.

An operating system 612 can be maintained as a computer executable module with the computer-readable media 608 and executed on processor 606. Device executable modules can also include an ad publishing platform 614 and an input/output module 616 as described above and below. Ad publishing platform 614 can be, for example, ad publishing platform 120. Input/output module 616 can be, for example, input/output module 126.

Device 600 also includes an audio and/or video input/output 618 that provides audio and/or video data to an audio rendering and/or display system 620. The audio rendering and/or display system 620 can be implemented as integrated component(s) of the example device 600, and can include any components that process, display, and/or otherwise render audio, video, and image data.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable storage devices. The features of the techniques described above are platform-independent, meaning that the techniques may be implemented on a variety of commercial computing platforms having a variety of processors.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

What is claimed is:

1. A computer-implemented method comprising:
receiving, from a client device, a request for an advertisement;
determining a template to be used to generate the advertisement according to at least one property of the request;
inputting metadata provided by an advertiser into the template effective to generate the advertisement; and
transmitting, to the client device, the advertisement.

2. The computer-implemented method of claim 1, determining the template comprising determining one of a plurality of templates selected by the advertiser to be used to generate the advertising.

3. The computer-implemented method of claim 1, wherein the at least one property of the request comprises information regarding the client device from which the request was received, information regarding a user, or a web page on which the advertisement will be presented.

4. The computer-implemented method of claim 3, wherein the information regarding a user comprises information regarding a previous interaction of the user with the advertiser.

5. The computer-implemented method of claim 1, further comprising:
receiving, from the advertiser, the metadata, the metadata comprising an image, identification information for the advertiser on a third party site, a location, a phone number, an object identification code, or a uniform resource indicator.

6. The computer-implemented method of claim 5, wherein the metadata input into the template is configured to cause an integration of a third party service into the advertisement.

7. One or more computer-readable storage media comprising instructions that are executable to cause a device to perform a process comprising:
receiving, from an advertiser, a selection of templates for use in generating advertisements, each template comprising one or more blocks for content that can be included;
receiving, from the advertiser, metadata associated with content to be included in one or more blocks of each template in the selection of templates;
determining, responsive to receiving a request for an advertisement, a template from the selection of templates for use in generating the advertisement corresponding to the request; and
inputting the metadata into the template effective to generate the advertisement and to cause integration of a third party service into the advertisement.

8. The one or more computer-readable storage media of claim 7, wherein receiving metadata comprises receiving an image, identification information for the advertiser on a third party site that provides the third party service, a location, a phone number, an object identification code, or a uniform resource indicator.

9. The one or more computer-readable storage media of claim 7, wherein determining the template comprises using a decision tree to determine the template from the selection of templates for use in generating the advertisement.

10. The one or more computer-readable storage media of claim 7, wherein determining the template comprises determining, based on a device from which the request was received, the template from the selection of templates.

11. The one or more computer-readable storage media of claim 7, wherein determining the template comprises determining, based on a web page on which the advertisement will be served, the template from the selection of templates.

12. The one or more computer-readable storage media of claim 7, wherein determining the template comprises determining, based on a previous interaction of a user with the advertiser, the template from the selection of templates.

13. A device comprising:
one or more processors;
one or more computer-readable storage media; and
one or more modules embodied on the one or more computer-readable storage media and executable under the influence of the one or more processors, the one or more modules configured to:
store a selection of templates for use in generating one or more advertisements on behalf of an advertiser;
store one or more components provided by the advertiser, the one or more components comprising one or more of an image, identification information for the advertiser on a third party site, a location, a phone number, an object identification code, or a uniform resource indicator; and
generate, by inputting the one or more components into a template from the selection of templates, an advertisement having an integrated third party service.

14. The device of claim 13, wherein inputting the one or more components into the template comprises inputting one or more of identification information for the advertiser on a third party site, a location, a phone number, an object identification code, or a uniform resource indicator into the template effective to cause a third party service to be integrated into the advertisement.

15. The device of claim 13, wherein the selection of templates comprises one or more of a template for use when the advertisement will be rendered by a mobile device, a template for use when the advertisement will be rendered by a mobile device, a template for use when the advertisement will be part of a search result page view, a template for use when the advertisement will be part of a browse page view, a template for use when the advertisement targets a user in a sales funnel.

16. The device of claim 13, wherein generating an advertisement comprises generating a plurality of advertisements by inputting the one or more components into each template in the selection of templates, and wherein the one or more modules are further configured to:
select, based on a property of a received request for the advertisement, the advertisement from the plurality of advertisements.

17. The device of claim 13, the one or more modules being further configured to:
select, based on a property of a received request for the advertisement, the template from the selection of templates.

18. The device of claim 17, wherein the property of the request comprises information regarding a client device from which the request was received, information regarding a user, or a web page on which the advertisement will be presented.

19. The device of claim 17, wherein a decision tree is utilized to select the template from the selection of templates.

20. The device of claim 17, wherein the one or more modules being configured to select the template from the selection of templates comprises the one or more modules being configured to:
select a first template from the selection of templates responsive to the received request being received from a first device; and
select a second template from the selection of templates responsive to the received request being received from a second device.
